(19) United States
(12) Patent Application Publication
(10) Pub. No.: US 2003/0051472 A1
(43) Pub. Date: Mar. 20, 2003

(54) System or principle of replenished electric power, strong enough to power the world

(76) Inventor: Charles Gene Thrasher, Hallettsville, TX (US)

Correspondence Address: Charles Gene Thrasher, 626 County Road 126, Hallettsville, TX, 77964, US

(21) Appl. No.: 09/912,668

(22) Filed: Sep. 20, 2001

(51) Int. Cl. F16D 31/02

(52) U.S. Cl. 60/398

(57) ABSTRACT

This is a system or principle of replenished electric power. With no out side fuel source, has water fossil or atomic. This can be made in several ways. To power a city or the world. To run cars, trucks, airplanes are made small for sorts of jobs. This is my own idea.

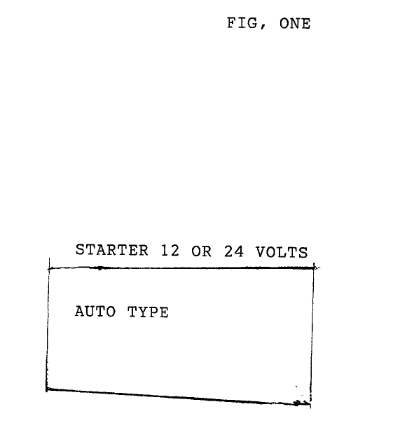

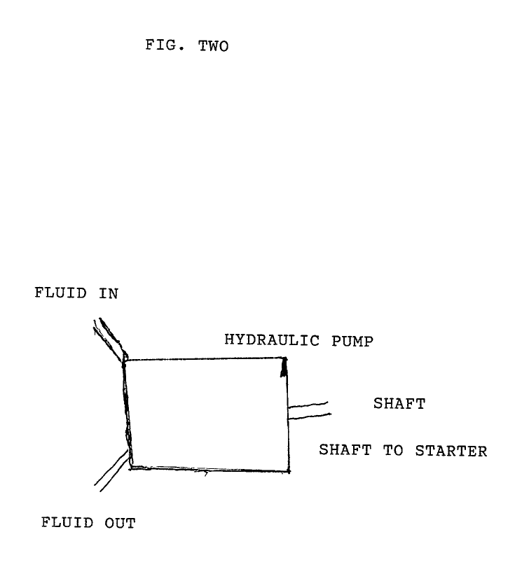

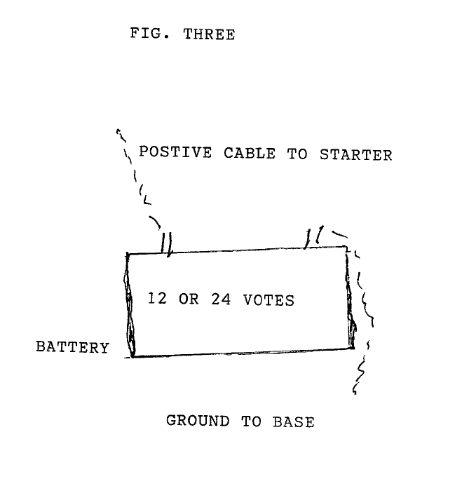

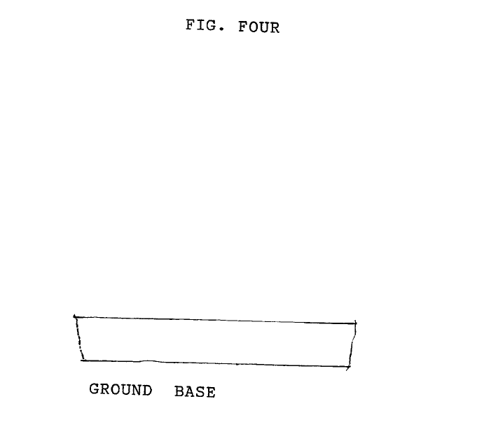

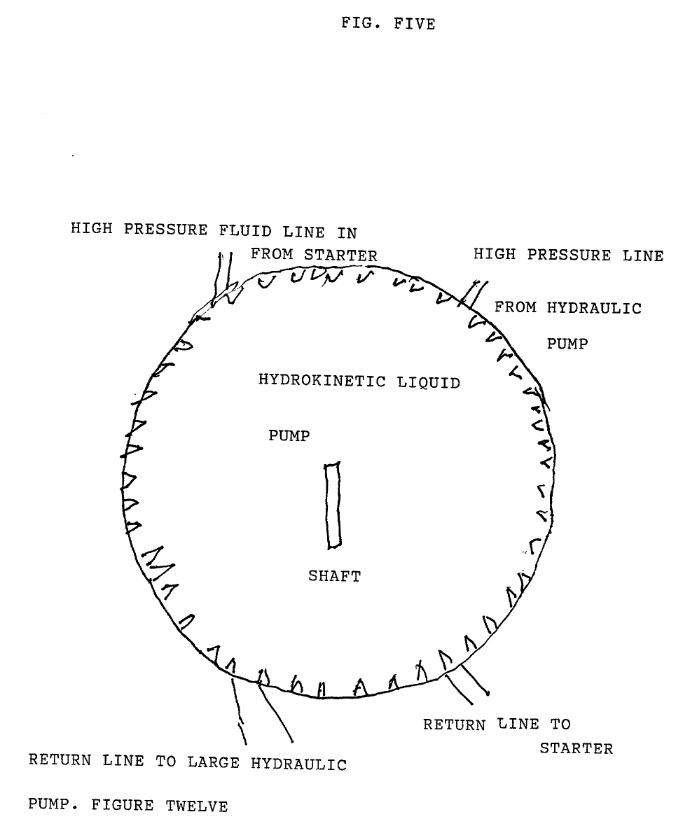

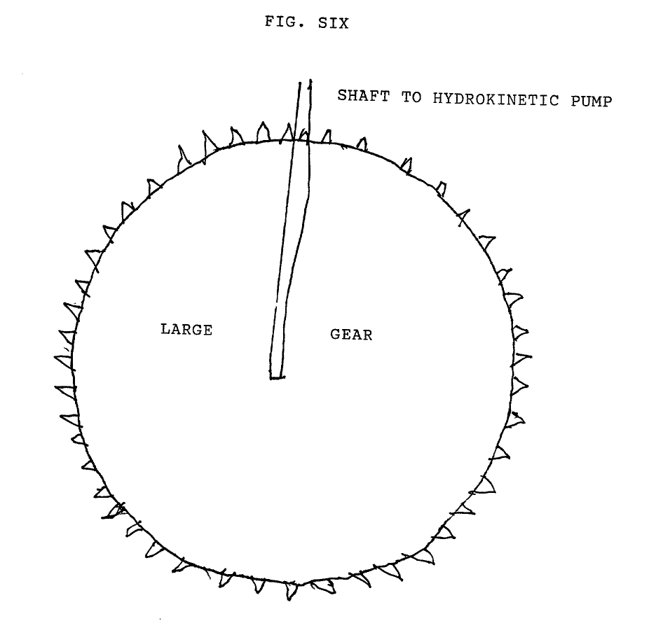

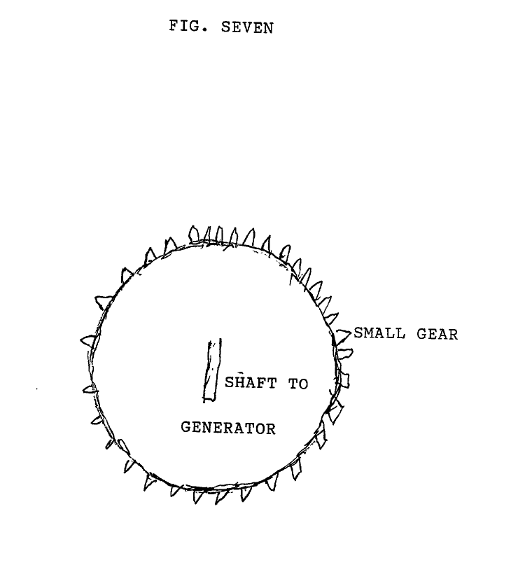

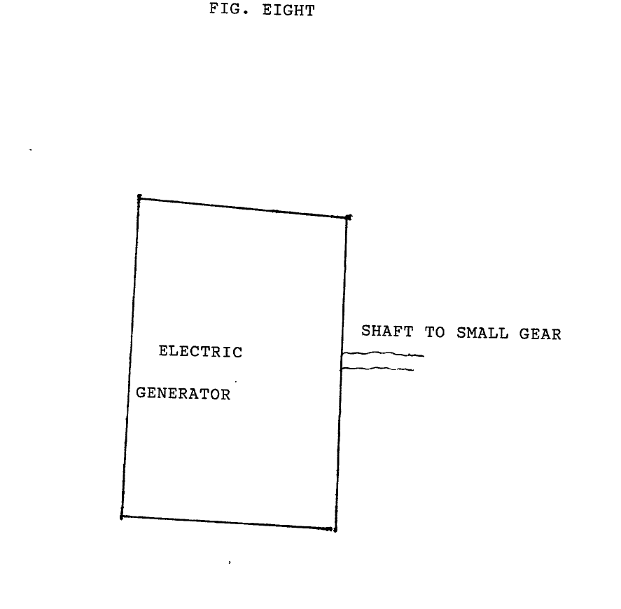

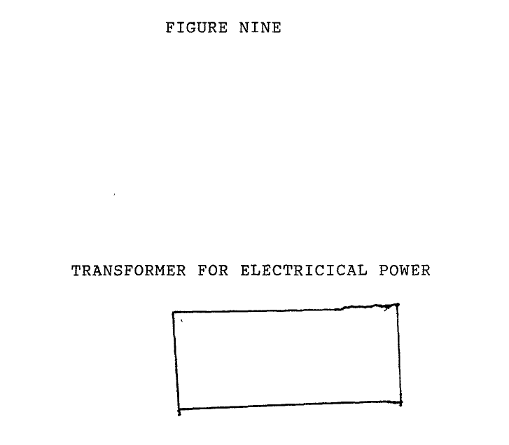

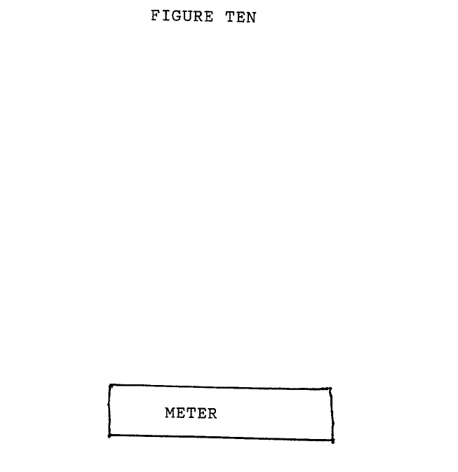

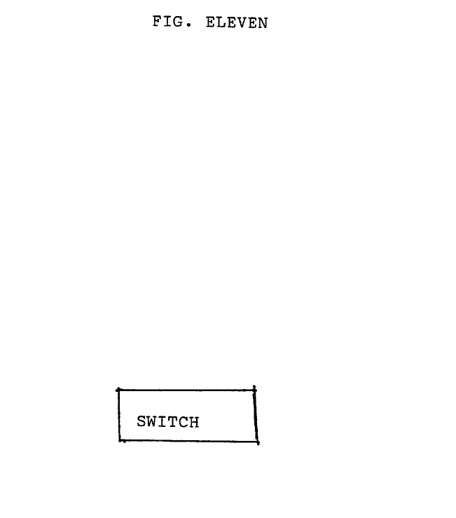

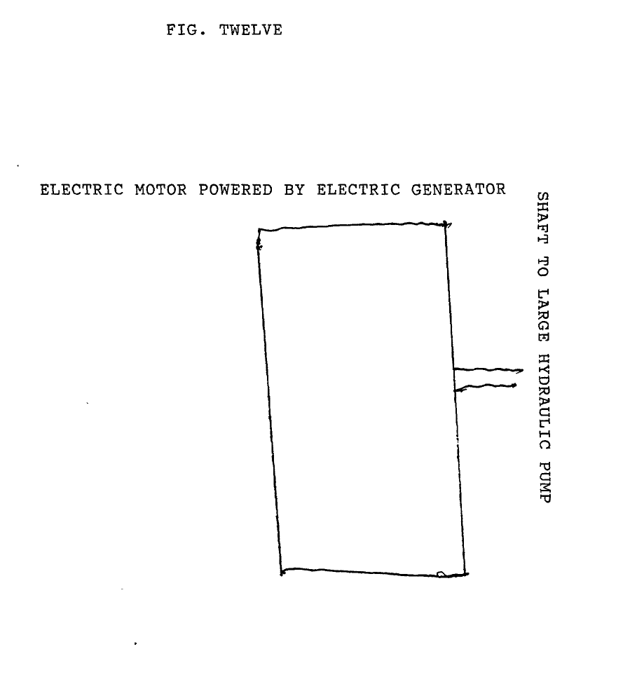

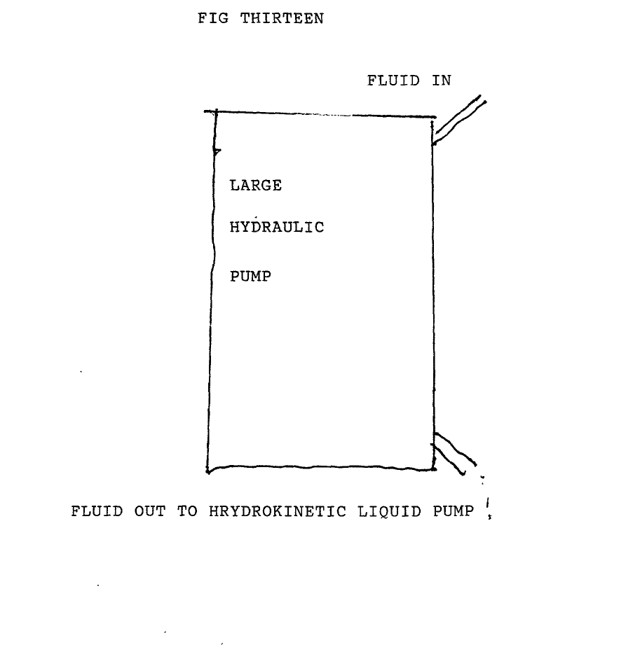

### BACKGROUND OF INVENTION

Electricity is used by all modern poeple. For all sorts of power need.

Electricity in the past was and is made most by the use of out side fuel source. Used to turn generators to make power.

This is not necessary. For a system or principle of replenished electric power. Will make and enlarge the electricity for the hold world. This is a effort of thirty years work. Plus the good will of god.

Page one figure one is a starter 12 volts kor larger auto type.

Page two figure two is a hydraulic pump that has connection to starter and lines to and from page five figure five.

Page three is a battery can be of any size as it needs to be. This powers page one figure one.

Page four is a ground base.

Page five figure five is a hydrokinetic liquid pump. This powers a large gear. Page six figure six. Which turns a small gear. That can be sized for any ratio.

Thru the shaft turns page seven figure seven to page eight figure eight a large generator that can be sized for amount of power wanted.

Thru this generator. A regular line of electric power is used to power page nine figure nine a transformer for electric power. To page ten figure ten a meter. To a switch page eleven figure eleven. To a electric motor page twelve figure twelve. This motor can be sized for amount of power wanted for page thirteen figure thirteen. Which is a hydraulic pump sized to needs of figure five a hyrokinetic liquid pump. Thru this the system repeats it self. Replenish it self and enlarges it self to any size needed.

Specification for pages one thru thirteen pages fourteen thru seventeen is a system to make electric power. In all sizes.

Page fourteen is alternator with a regulator, one hundred anps. Larger or smaller. This thru a pulley and belt to page sixteen figure sixteen is a electric motor. That can be of ant size. Thru figure fifteen on page fifteen is a battery that powers the alternator. That replenish it self plus enlarge it self. For power that works till failure of parts.

Figure fifteen powers the motor that turns the alternator page fourteen figure, which powers the battery.

Page five figure five is a hydrokinetic liquid pump.

That turns page sic figure six a large gear that that turns page seven figure seven a small gear with a shaft turns page eight figure eight a electric generator. To page nine figure nine a transformer to page ten figure ten a meter to page eleven figure eleven a switch. To page twelve figure twelve a electric motor. That is power by a out side source of electric power. That turns a hudraulic pump page thirteen figure that turns figure five and starts the system all over again. This makes more power than is used by motor.

What I claim as my invention is:

1. A system or principle of replenished electric power strong strong enough to power the world. As with the making of electric power. With water, fossil fuel or atomic. That use of power as to be replaced. My system or principle will make electric power that will replenish it self. Plus enlarge its self. Thru duplication of the system. To power any need. With out fossil fuel, water or atomic power. Demonstrated three ways. Pages one thru thirteen. Pages fourteen thru seventeen Pages five thru thirteen.
